(19) United States
(12) Patent Application Publication
(10) Pub. No.: US 2023/0325821 A1
(43) Pub. Date: Oct. 12, 2023

(54) SYSTEM AND METHOD FOR NON-FUNGIBLE TOKENIZED DISTRIBUTION OF CRYPTOGRAPHICALLY SECURED DIGITAL ASSETS FOR APPAREL

(71) Applicants: Jonathan Honig, Boca Raton, FL (US); Erich Lawson Spangenberg, Paris (FR)

(72) Inventors: Jonathan Honig, Boca Raton, FL (US); Erich Lawson Spangenberg, Paris (FR)

(21) Appl. No.: 18/116,824

(22) Filed: Mar. 2, 2023

Related U.S. Application Data
(60) Provisional application No. 63/316,288, filed on Mar. 3, 2022.
(60) Provisional application No. 63/327,194, filed on Apr. 4, 2022.

(51) Int. Cl. G06Q 20/38; G06Q 40/04; G06T 19/00; G06Q 20/12

(52) U.S. Cl. CPC G06Q 20/38215; G06Q 40/04; G06T 19/006; G06Q 20/123; G06Q 20/389

(57) ABSTRACT

The present invention is a system and method for the purchase of a physical athletic jersey and its associated NFT and how it could be implemented in both the physical world and the Metaverse. Within the Metaverse, the consumer's avatar wears the jersey and can attend virtual social events to increase the value and price of the NFT. Once the NFT is developed, it can be sold and licensed. Within the physical world, the NFT can be shown at participating venues for the consumer to receive promotions or discounts. Along with the physical jersey and NFT is a corresponding insurance policy, which ensures that if the player associated with the jersey and NFT is traded or switches teams, the consumer can receive either a new player's jersey on the same team or the original player's jersey on the new team. The present invention generates additional revenue streams for the providers of sports apparel and collectible memorabilia, through provenance verification and NFT value augmentation, so that both sport apparel sellers and buyers may gain revenue streams apart from the simple sale of the article at POS.

### CROSS-REFERENCE TO RELATED APPLICATIONS

This application claims the benefit of U.S. Provisional Patent Application Ser. No. 63/316,288, filed on Mar. 3, 2022, and U.S. Provisional Patent Application Ser. No. 63/327,194, filed Apr. 4, 2022, the contents of which are incorporated herein by reference.

### BACKGROUND OF THE INVENTION

The Metaverse is a combination of virtual reality, augmented reality, and technology, where users can “live” in a digital universe. It is a 3D online virtual environment in which users can work, play, and interact with others, like what they do in the real, physical world. Virtual reality creates virtual worlds that exist even when one is out of the Metaverse. Augmented reality combines aspects of the digital and physical world which can be accessed through personal computers, virtual, or augmented headsets. The Metaverse also includes a digital economy in which users can create, buy, and sell goods. Virtual identities in the Metaverse are akin to avatars, with personal identities and personas that can be created within the Metaverse. The Metaverse is meant to weave a stronger connection between our digital and physical worlds in wealth, socialization, productivity, entertainment, and shopping.

An NFT is a non-fungible token, which is a unique unit of data stored in a blockchain, which is a digital ledger. These digital files include photos, videos, and audio. The digital ledger provides public proof of ownership, but that does not restrict the owner from sharing or copying the file and allows the NFT to be sold or traded on digital markets.

Within the physical world, there is the ability to buy physical athletic jerseys, and in some examples, insure them. There has yet to be a market to replicate this interaction in the Metaverse. Therein exists an opportunity to create a connection between the physical and virtual world by connecting a physical jersey to an NFT jersey that can be worn in the Metaverse on applications and devices such as Stadium Live, RTFKT, Roblox, Xbox, and Nintendo Switch, all where players can interact with other users while wearing their own jersey NFT. With this connection, there also exists a need for an insurance policy that can be placed on both the physical and NFT jerseys. Indeed, at present, jerseys said to have been worn to a certain “big game” cannot be verified to have been so worn. Also, within the physical world, a problem exists that valuable sports apparel becomes “worn out” the more it is worn to sporting events. There exists a need so that owners and wearers of sports apparel may capture the value attained by the sport apparel being work to “choice” or “prestigious” athletic or high profile events.

### SUMMARY OF THE INVENTION

The present invention pertains to a system and method for non-fungible tokenized distribution of cryptographically secured digital assets for apparel or collectibles, including specifically sports merchandise such as athletic jerseys. In addition, the system and method of the present invention enables the monetization of the provenance and popularity of a desirable article (e.g., a sports jersey and the NFTs associated with it, a collectible card and its associated art work and the NFTs associated with it, a particular social media identity and its associated art work and the NFTs associated with it, etc.). In this invention, the consumer goes to a brick-and-mortar store (BMS) of a partnering brand and purchases a physical athletic jersey or accomplishes the same via e-commerce by having the physical good delivered to the consumer.

The physical good may be sport attire, sport memorabilia, collectibles relating to video games such as Pokemon brand card, or any other artistically significant collectible or uniquely authored collectible. The consumer can pay for the jersey through cash, credit, debit, and cryptocurrency at a point-of-sale (POS) terminal associated with the BMS, or via any e-commerce outlet. As an alternative, there may be a verification step wherein the proof purchase data can be recorded to the blockchain and cross referenced with the POS data from the retailer. Once the payment is received, the consumer will also receive an NFT associated with the physical jersey or any other physical article according to the present invention. The physical jersey and corresponding NFT come with an optional insurance policy including proof of title, risk against casualty loss and protection against loss of value (in other words, for example, a player is traded away from a team potentially diminishing the value of the jersey or the player's number is changed, or purchase was associated with a team leader (e.g., quarterback) who has been replaced with a new team leader, etc.). The insurance policy may be customized, and endorsements sold to a user to ensure that if the sports player of the purchased jersey is traded or switches teams within one year of purchase, the consumer can receive either a new player jersey on the same team or the same player jersey on the new team and receives a new “updated” associated NFT.

The consumer will then upload their NFT onto their NFT wallet and into a specific platform, which will allow them to link the NFT to the Metaverse. The consumer can use the NFT as a wearable for their avatar while in the Metaverse. While wearing the NFT jersey, the avatar can go to virtual social events and can be worn while playing games within the Metaverse. Through these virtual events and games as means, the value and price of the NFT will both increase and develop. Through the use of the NFT in the Metaverse, its owner can earn brand loyalty credits, and credits associated with the underlying NFT and its associated art work and real-life players. These credits may enable the purchase of associated goods and services: more memorabilia, credits for real life and Metaverse gaming (Fan Duel, Draft Kings, etc.), credits for attendance at real life events (via Stub Hub, for example), and even draft preference positioning for fantasy sports participation and betting.

This platform is a place for users to upload their athletic jersey NFTs purchased through partnering brands. On this platform, users can view other users' jerseys. When users view other users' NFTs, the value of the NFTs will increase in value. This platform works like a social media platform, giving users the opportunity to connect with others and view their NFTs. This platform is also where users can buy and sell developed NFTs. Likewise, the more users wear their real-life jerseys, the more they can earn NFT-based credits. For examples, “selfies” posted on social media with the sports attire work may lead to an increase in the value of that user's NFT valuation. In other words for the first time, the user usage of a sports jersey and subsequent display upon social media or its “usage provenance” will lead to an increase in value of the NFT associated with that purchased article, so that as the physical article and its associated NFT is sold or traded, its “usage provenance” is factored into its value. Accordingly, users will become more interested in purchasing more sports jerseys or memorabilia and in turn will want to post more of their images to social media to drive value.

Wearing the physical jersey in the real world (every day) will also add to the increase and development of the value of the jersey and the NFT. Through partnerships with athletic jersey shops, like Fanatics, or ticketing sites, like StubHub, when a consumer wears their jersey to an actual sporting event, the value of their jersey will increase. For example, a consumer with a Joe Burrow jersey and associate NFT buys a ticket for a Bengals game through StubHub and wears their Joe Burrow jersey to the game, the value of the NFT increases.

The tracking of the physical jersey in the real world will be done through an app and the apparel may even include wearable technology, with RFID tags. This app will allow the consumer to input the information of the physical jersey and the associated NFT. When the consumer goes to real events wearing the jersey, they will input this information and upload a photo of the physical jersey, and through the use of GPS tracking, the app will be able to confirm the consumer is at this event. For example, a consumer purchases a Joe Burrow jersey then goes to a Bengals game. At the Bengals game, the consumer will take a picture of the jersey at the stadium and upload this to the tracking app. The app will confirm the consumer is at the Bengals game wearing the Joe Burrow jersey and will increase the value of the consumer's Joe Burrow NFT. This tracking app will keep track of the physical jersey in the real world, increase the value of the associated NFT in the Metaverse, and record this all in the Blockchain. This app will be like a loyalty program, the more the physical jersey is worn out, the more the consumer will earn for the NFT.

With this NFT, the consumer can receive discounts and promotions at participating bars or restaurants in the physical world. If the consumer wears the physical jersey to a participating bar or restaurant while the team's game is on, the consumer can also add this into the tracking app to increase the value of the NFT. For example, a consumer goes to Buffalo Wild Wings to watch the Bengals game. If the consumer is wearing the Joe Burrow jersey they own, they can take a photo to upload into the tracking app to increase the value of their Joe Burrow NFT. The consumer also receives advantages while using online betting apps or fantasy sport apps. Some of these advantages include receiving the number 1 draft pick on a fantasy app or the ability to draft the player of their NFT early in the draft.

Once the NFT is developed, the consumer can sell or license the NFT. This can be done through cryptocurrency or Venmo via the exchange platform. The more developed the NFT is, through going to various events in the Metaverse and in the real world, the more valuable the NFT becomes, and the higher the price of the NFT is.

The consumer can own multiple physical jerseys and jersey NFTs. Within the Metaverse, the consumer can pick and choose which jersey NFT to wear while frequenting events and playing games. On the platform, all these jersey NFTs can be on display for users to see when a jersey is not being worn by an avatar. This allows the consumer to develop every NFT as well as provide multiple opportunities to sell and license various NFTS.

By way of the present invention, a system and method is taught whereby branding may be augmented or conducted through a use of wearable technology, where users may purchase NFT associated with athletic apparel that they own, and in turn, the users may generate value by increasing the provenance of their athletic apparel by wearing the apparel at memorable events. In turn, that apparel and its associated NFT may be marketed, traded or leased to other individuals, for future memorable sporting events, or even sold as a collectable and never worn again. In this manner, users can have two items of value whereby presently, only one item of value exists, and is susceptible to becoming “worn out”. With the present invention, as the physical item “wears out”, the associated NFT may gain in value, reflecting the provenance as to where the physical item was worn or otherwise presented (e.g., a flag or banner).

Other features and aspects of the invention will become apparent from the following detailed description, taken in conjunction with the accompanying drawings, which illustrate, by way of example, the features in accordance with embodiments of the invention. The summary is not intended to limit the scope of the invention, which is defined solely by the claims attached hereto.

### BRIEF DESCRIPTION OF THE DRAWINGS

The various embodiments are illustrated by way of example, and not by way of limitation, in the figures of the accompanying drawings. Having thus described the invention in general terms, reference will now be made to the accompanying drawings, which are not necessarily drawn to scale, and wherein:

FIG. 1 is an overview of the present invention describing the process of the consumer buying the jersey and associated NFT and what that entails.

FIG. 2 is a diagram showing what the consumer receives in the purchase of the NFT and how it relates to the Metaverse in the process of the present invention.

FIG. 3 is a diagram of how the NFT can be used within the Metaverse and outside of it in the present invention.

FIG. 4 is a diagram showing the jersey NFT once it is uploaded into the Metaverse.

FIG. 5 is a diagram showing the ways to increase the value and price of the jersey NFT in the Metaverse.

FIG. 6 is a diagram of how the consumer can use their jersey NFT in the Metaverse to increase the value and price.

FIG. 7 is a line diagram illustrating a decentralized network.

FIG. 8 is a line diagram illustrating a distributed network.

FIG. 9 is an illustration depicting an exemplary operating environment including one or more user computers, computing devices, or processing devices, which can be used to operate a client, such as a dedicated application, web browser is shown.

FIG. 10 is another illustration depicting an exemplary operating environment including a computer system with various elements as shown.

FIG. 11 is a diagram illustrating the Smart Contracts recorded into the Blockchain.

FIG. 12 is a flow diagram of the tracking app of the present invention.

FIG. 13 is a diagram of the tracking app of the present invention.

FIG. 14 is a diagram of the platform of the present invention.

FIG. 15 is a diagram depicting the platform's web service infrastructure.

FIG. 16 is a depiction of the platform's web services, as well as the components of an exemplary operating environment in which embodiments of the present invention may be implemented.

FIG. 17 is an illustration of a multi-server room and the various locations in which other pertinent server rooms may exist.

FIG. 18 is a diagram outlining the web services incorporated with server-client communication.

FIG. 19 is a diagram of the flow of access between the platform of the present invention and the web services client via cloud software tools.

FIG. 20 is a diagram of an example of the cloud storage organization in which the web services accesses and retrieves user data as objects in buckets within a cloud storage space.

### DETAILED DESCRIPTION OF THE PREFERRED EMBODIMENT

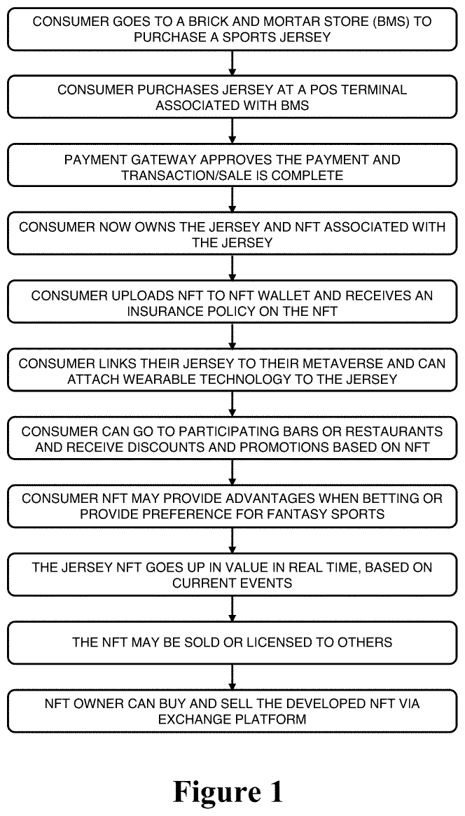

FIG. 1 is an overview of the present invention. The consumer goes to a brick-and-mortar store (BMS) and purchases a jersey. The same may be achieved via e-commerce and delivery. The consumer can purchase the jersey using payment methods such as cash, credit, debit, or crypto wallet funds at a POS terminal associated with BMS. A payment gateway approves the payment, and the consumer now owns the jersey and associated NFT. As an alternative, there may be a verification step wherein the proof purchase data can be recorded to the blockchain and cross referenced with the point-of-sale data from the retailer. The consumer takes the jersey home and uploads the associated NFT to their NFT wallet and receives an insurance policy on the NFT. Once the NFT is uploaded onto their NFT wallet, the consumer can link the jersey to their Metaverse and can attach a wearable to their jersey so their avatar can wear the jersey.

The consumer can go to participating bars/restaurants and with their NFT and potentially receive discounts or promos offered only to consumers with these NFTs. These NFTs can also give the consumer advantages in online betting websites or in real life gambling experiences with the use of cryptocurrency. These NFTs can also provide the consumer with advantages in fantasy sport apps, like being able to draft the player they have an NFT for earlier.

The jersey NFT goes up in value in proportion to where the jersey has been in the Metaverse. Venues like games, nightclubs, restaurants, hotels, etc. are places where the NFT's value can grow and develop. The NFT can be sold and licensed to others for certain periods of time. These NFTs can also be sold and licensed to be worn only in certain locations by others. The price of how much the NFT is sold and licensed for is based on the value of the NFT and can be sold through Venmo or cryptocurrency. Loyalty brand credits can also be built around the NFT. This will all be done through a NFT exchange platform so the holder can easily sell and license their NFT while building and developing the value of the NFT.

The physical jersey and corresponding NFT may come with an optional insurance policy including proof of title, risk against casualty loss and protection against loss of value (in other words, for example, a player is traded away from a team potentially diminishing the value of the jersey or the player's number is changed, or purchase was associated with a team leader (e.g., quarterback) who has been replaced with a new team leader, etc.). The insurance policy may be customized, and policy endorsements sold to the user and designed to ensure that if the player of the purchased jersey is traded or switches teams within one year of purchase, the consumer can receive either a new player jersey on the same team or the same player jersey on the new team and receives a new “updated” associated NFT. A user can purchase any number of “insurance” options or endorsements, all entered onto a Blockchain along with the NFT associated with the sports article purchase. In this manner, the brand sponsor (e.g., Fanatics) may make money on the jersey, the NFT associated with the jersey, and the myriad of insurance products the user desires to purchase to protect the article, the NFT associated with the article, and moreover, the usage history or provenance associated with the wearable history of that article, in terms of where it was worn, how often, how often posted and its Metaverse impact and score. Furthermore, by way of the present invention, a user may create in the Blockchain associated with the present invention that in fact, the jersey was worn at a “big game” such as a Super Bowl, and the like. In that way, a user may monetize the provenance associated with their sports articles and associated NFTs.

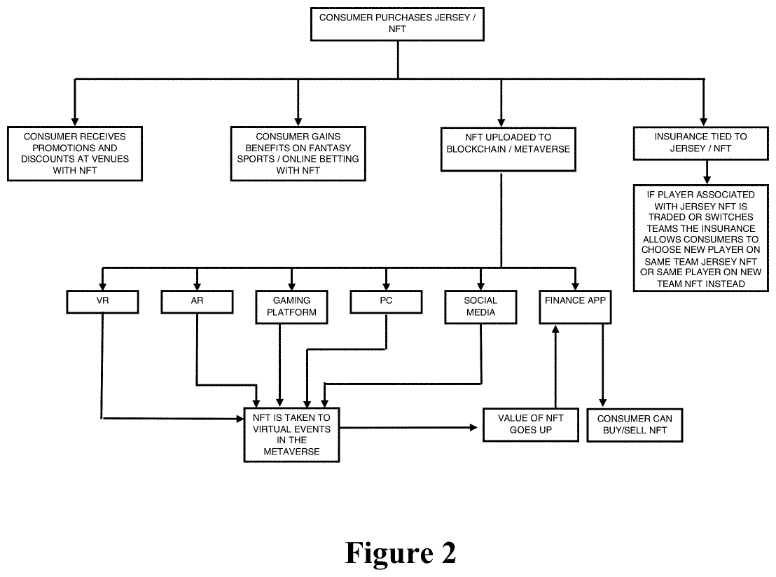

FIG. 2 is a diagram showing what the consumer receives in the purchase of the NFT and how it relates to the Metaverse in the process of the present invention. With the purchase of a jersey and the associated NFT, the consumer can receive discounts and promotions at participating venues as well as benefits on fantasy sports and online betting apps. The consumer will also receive an insurance policy with the NFT. This insurance policy ensures if the player associated with the jersey and NFT is traded or switches teams, the consumer may get a new jersey of a different player on the original team, or the original player on the new team.

When the consumer uploads their NFT to the blockchain and Metaverse therein, the consumer can access the NFT through VR, AR, gaming platforms, PC, social media, and finance apps. Through VR, AR, gaming platforms, PC, and social media, the consumer can attend virtual events while wearing the NFT jersey. This then makes the value of the NFT increase. Through finance apps, the consumer can see the increase in value of their NFT and able to buy and sell NFTs.

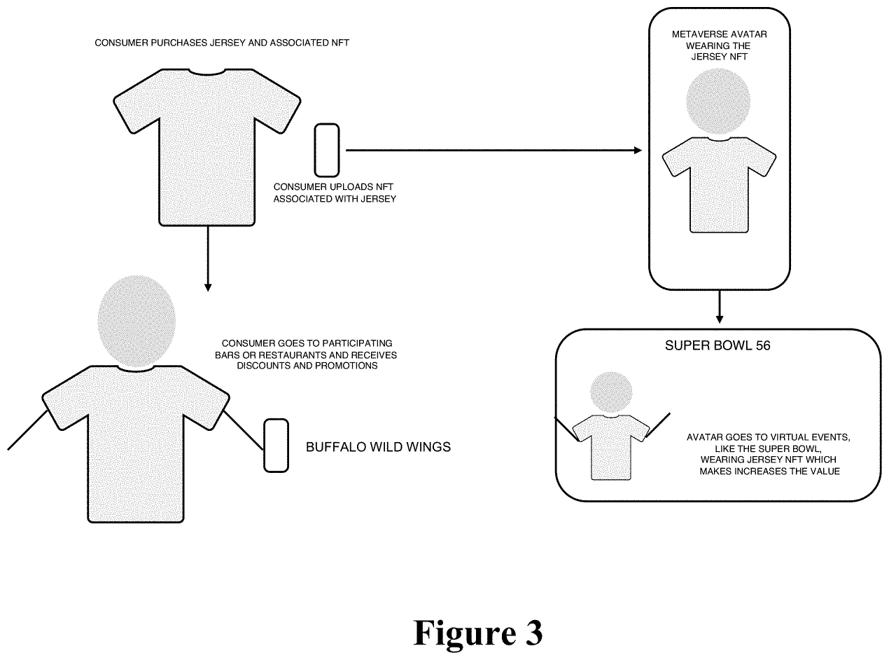

FIG. 3 is a diagram of the NFT Metaverse process of the present invention. When the consumer purchases the jersey and associated NFT, they can upload their NFT onto their NFT wallet. This then allows the consumer to have the NFT jersey as a wearable for their avatar in the Metaverse. When the avatar goes to virtual events in the Metaverse, like the Super Bowl, the value of the NFT increases. The consumer is also able to show the NFT at participating venues in the real world, like Buffalo Wild Wings, and receive discounts and promotions.

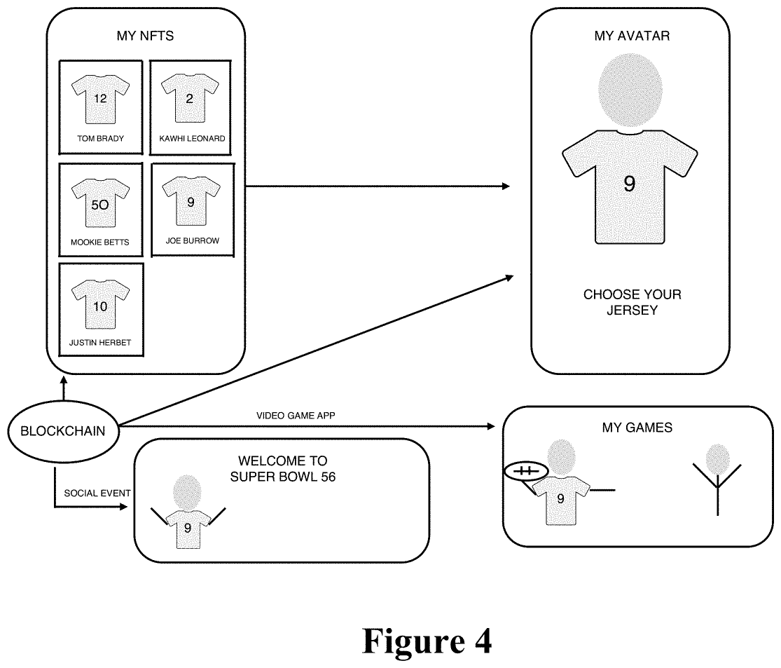

FIG. 4 is a diagram showing the jersey NFT once it is uploaded into the blockchain of the Metaverse. All jersey NFTs purchased by the consumer will be positioned in a central spot which will allow the consumer to pick and choose which jersey NFT they want their avatar to wear. While wearing the jersey NFT, the consumer can go to virtual social events in the Metaverse. Through video game apps, the consumer can play games while wearing the jersey NFT.

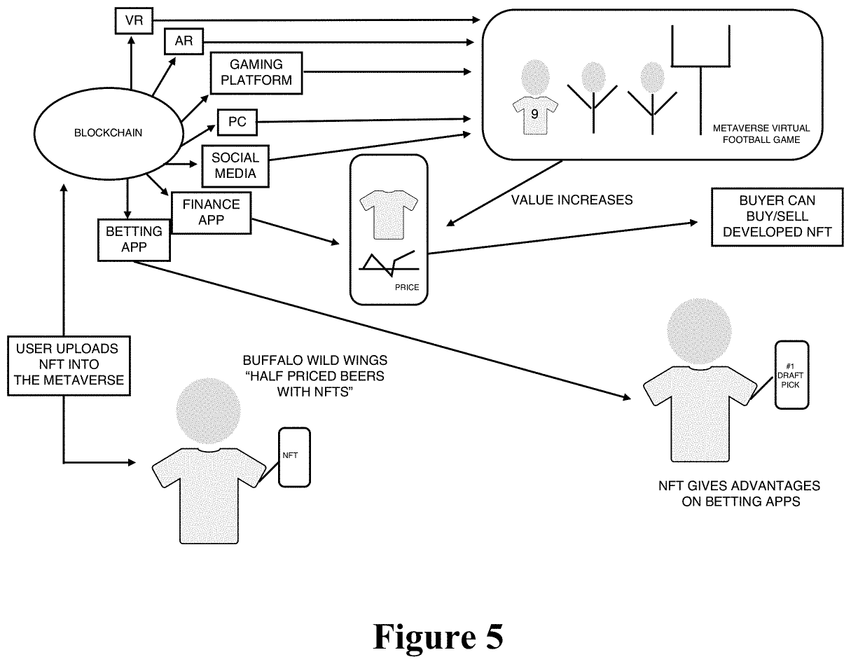

FIG. 5 is a diagram showing how in the present invention the jersey NFT can be used to increase in value and price. When the NFT is uploaded into the Metaverse, it is uploaded into a blockchain, which keeps track of the NFT through all the different devices the Metaverse uses. These devices include VR, AR, gaming platforms, PC, social media, finance apps, and betting apps. Using VR, AR, gaming platforms, PC, and social media, the jersey NFT can be worn by the avatar to go to virtual social events. This then increases the value and the price of the NFT, which can be seen through the finance apps. The finance apps also allow the consumer to buy and sell NFTs in the Metaverse. Through the use of betting apps, the consumer could reap benefits such as receiving the number 1 draft spot in a fantasy sport league. The NFT can also be shown at participating bars and restaurants to receive promotional deals and discounts.

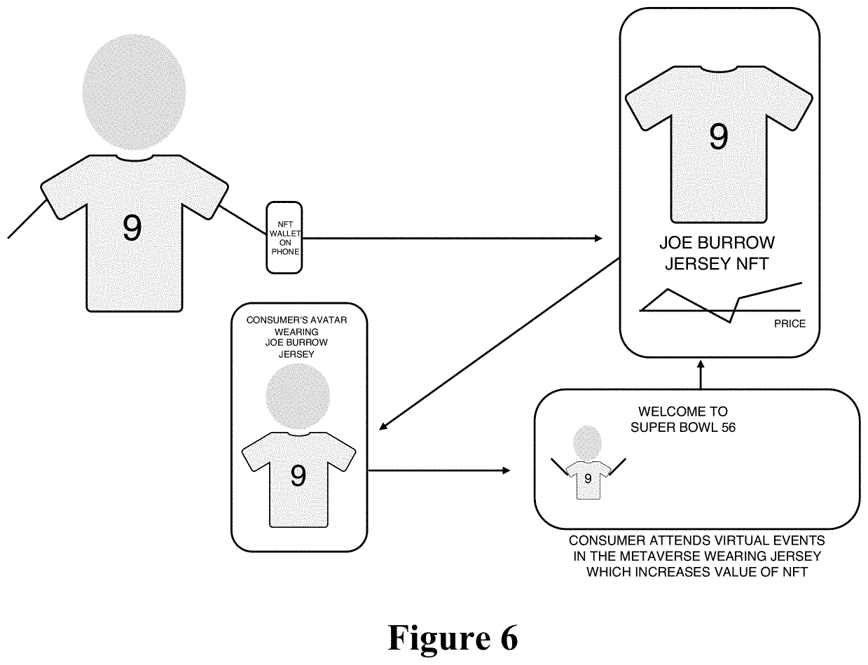

FIG. 6 is a diagram showing the consumer with the physical jersey and its NFT jersey and how with the present invention the NFT jersey can be used in the Metaverse. Once the physical jersey and associated NFT is purchased, the consumer will have the NFT jersey uploaded onto their NFT wallet on their phone. On their NFT wallet, they can track the increase or decrease in value and price of their jersey NFT. The consumer can have the jersey NFT as a wearable for its avatar which then can be taken to virtual events, and consequently increase the value and price of the NFT.

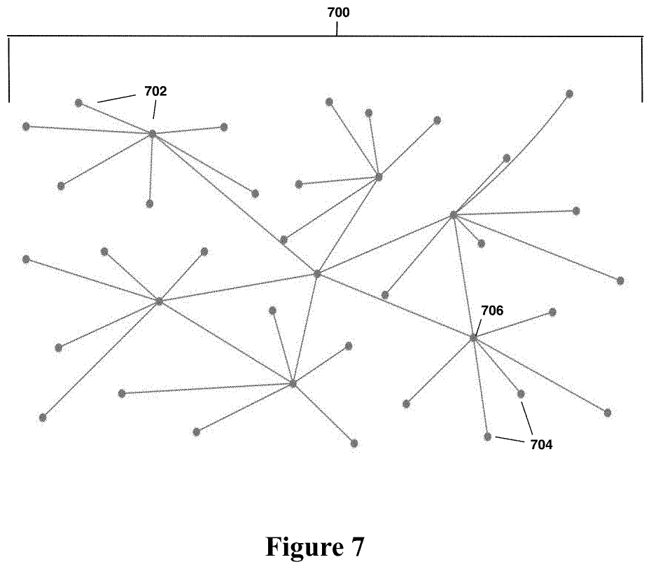

FIG. 7 is a line diagram illustrating a decentralized network. In accordance with the preferred embodiment of the present invention, the specific architecture of the network can be either decentralized or distributed. FIG. 7, generally represented by the numeral 700, provides an illustrative diagram of the decentralized network. FIG. 7 depicts each node with a dot 702 Under this system, each node is connected to at least one other node 704. Only some nodes are connected to more than one node 706.

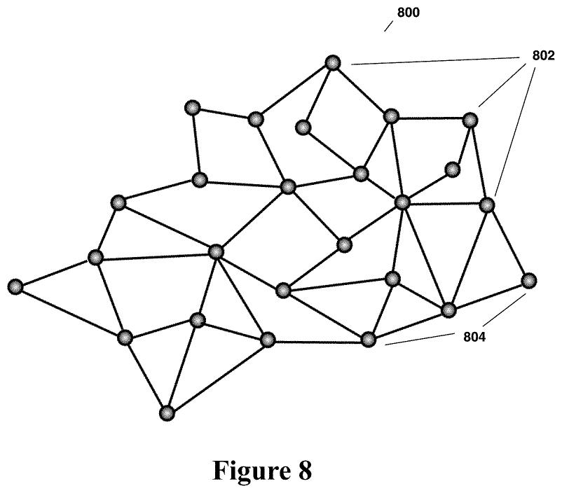

FIG. 8 is a line diagram illustrating a distributed network. For comparison purposes, FIG. 8, which is generally represented by the numeral 800, illustrates a distributed network. Specifically, the illustration shows the interconnection of each node 802 in a distributed decentralized network 800. In accordance with the preferred embodiment of the present invention, each node 802 in the distributed network 800 is directly connected to at least two other nodes 804. This allows each node 802 to transact with at least one other node 802 in the network. The present invention can be deployed on a centralized, decentralized, or distributed network.

In one embodiment, each transaction (or a block of transactions) is incorporated, confirmed, verified, included, or otherwise validated into the blockchain via a consensus protocol. Consensus is a dynamic method of reaching agreement regarding any transaction that occurs in a decentralized system. In one embodiment, a distributed hierarchical registry is provided for device discovery and communication. The distributed hierarchical registry comprises a plurality of registry groups at a first level of the hierarchical registry, each registry group comprising a plurality of registry servers. The plurality of registry servers in a registry group provides services comprising receiving client update information from client devices, and responding to client lookup requests from client devices. The plurality of registry servers in each of the plurality of registry groups provide the services using, at least in part, a quorum consensus protocol.

As another example, a method is provided for device discovery and communication using a distributed hierarchical registry. The method comprises Broadcasting a request to identify a registry server, receiving a response from a registry server, and sending client update information to the registry server. The registry server is part of a registry group of the distributed hierarchical registry, and the registry group comprises a plurality of registry servers. The registry server updates other registry servers of the registry group with the client update information using, at least in part, a quorum consensus protocol.

The present invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents.

Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

The units described above can be implemented as software components executing on one or more general purpose processors, as hardware such as programmable logic devices and/or Application Specific Integrated Circuits designed to perform certain functions or a combination thereof. In some embodiments, the units can be embodied by a form of software products which can be stored in a nonvolatile storage medium (such as optical disk, flash storage device, mobile hard disk, etc.), including several instructions for making a computer device (such as personal computers, servers, network equipment, etc.) implement the methods described in the embodiments of the present invention. The units may be implemented on a single device or distributed across multiple devices. The functions of the units may be merged into one another or further split into multiple sub-units.

The methods or algorithmic steps described in light of the embodiments disclosed herein can be implemented using hardware, processor-executed software modules, or combinations of both. Software modules can be installed in random-access memory (RAM), memory, read-only memory (ROM), electrically programmable ROM, electrically erasable programmable ROM, registers, hard drives, removable disks, CD-ROM, or any other forms of storage media known in the technical field.

Persons of ordinary skill in the art are able to understand that all or portions of the steps in the embodiments described above may be realized using programs instructing the relevant hardware and said programs can be stored on computer-readable storage media, such as a read-only memory, hard disk or compact disc. Optionally, all or portions of the steps of the embodiments described above may also be realized using one or multiple integrated circuits. Accordingly, the various modules/units contained in the embodiments above may also be realized in the form of hardware or software function modules. Thus, the present application is not limited to any specific combination of hardware and software.

The present application may have a variety of other embodiments and, without departing from the spirit and substance of the present application, persons skilled in the art may produce a variety of corresponding changes and modifications based on the present application, but these corresponding changes and modifications shall all fall within the scope of protection of the claims of this application.

Although the foregoing embodiments have been described in some detail for purposes of clarity of understanding, the invention is not limited to the details provided. There are many alternative ways of implementing the invention. The disclosed embodiments are illustrative and not restrictive.

While the invention has been described in detail and with reference to specific embodiments thereof, it will be apparent to those skilled in the art that various changes and modifications can be made therein without departing from the spirit and scope thereof. Thus, it is intended that the present invention cover the modifications and variations of this invention provided they come within the scope of the appended claims and their equivalents.

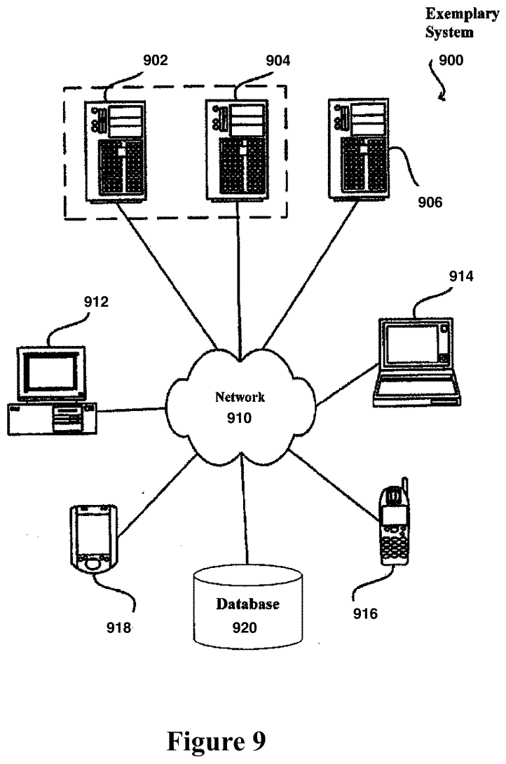

FIG. 9 is a block diagram illustrating components of an exemplary operating environment in which embodiments of the present invention may be implemented. The system 900 can include one or more user computers, computing devices, or processing devices 912, 914, 916, 918, which can be used to operate a client, such as a dedicated application, web browser, etc. The user computers 912, 914, 916, 918 can be general purpose personal computers (including, merely by way of example, personal computers and/or laptop computers running a standard operating system), cell phones or PDAs (running mobile software and being Internet, e-mail, SMS, Blackberry, or other communication protocol enabled), and/or workstation computers running any of a variety of commercially-available UNIX or UNIX-like operating systems (including without limitation, the variety of GNU/Linux operating systems). These user computers 912, 914, 916, 918 may also have any of a variety of applications, including one or more development systems, database client and/or server applications, and Web browser applications. Alternatively, the user computers 912, 914, 916, 918 may be any other electronic device, such as a thin-client computer, Internet-enabled gaming system, and/or personal messaging device, capable of communicating via a network (e.g., the network 910 described below) and/or displaying and navigating Web pages or other types of electronic documents. Although the exemplary system 000 is shown with four user computers, any number of user computers may be supported.

In most embodiments, the system 900 includes some type of network 910. The network can be any type of network familiar to those skilled in the art that can support data communications using any of a variety of commercially available protocols, including without limitation TCP/IP, SNA, IPX, AppleTalk, and the like. Merely by way of example, the network 910 can be a local area network (“LAN”), such as an Ethernet network, a Token-Ring network and/or the like; a wide-area network; a virtual network, including without limitation a virtual private network (“VPN”); the Internet; an intranet; an extranet; a public switched telephone network (“PSTN”); an infra-red network; a wireless network (e.g., a network operating under any of the IEEE 802.11 suite of protocols, GRPS, GSM, UMTS, EDGE, 2G, 2.5G, 3G, 4G, Wimax, WiFi, CDMA 2000, WCDMA, the Bluetooth protocol known in the art, and/or any other wireless protocol); and/or any combination of these and/or other networks.

The system may also include one or more server computers 902, 904, 906 which can be general purpose computers, specialized server computers (including, merely by way of example, PC servers, UNIX servers, mid-range servers, mainframe computers rack-mounted servers, etc.), server farms, server clusters, or any other appropriate arrangement and/or combination. One or more of the servers (e.g., 906) may be dedicated to running applications, such as a business application, a Web server, application server, etc. Such servers may be used to process requests from user computers 912, 914, 916, 918. The applications can also include any number of applications for controlling access to resources of the servers 902, 904, 906.

The Web server can be running an operating system including any of those discussed above, as well as any commercially-available server operating systems. The Web server can also run any of a variety of server applications and/or mid-tier applications, including HTTP servers, FTP servers, CGI servers, database servers, Java servers, business applications, and the like. The server(s) also may be one or more computers which can be capable of executing programs or scripts in response to the user computers 912, 914, 916, 918. As one example, a server may execute one or more Web applications. The Web application may be implemented as one or more scripts or programs written in any programming language, such as Java®, C, C# or C++, and/or any scripting language, such as Perl, Python, or TCL, as well as combinations of any programming/scripting languages. The server(s) may also include database servers, including without limitation those commercially available from Oracle®, Microsoft®, Sybase®, IBM® and the like, which can process requests from database clients running on a user computer 912, 914, 916, 918.

The system 900 may also include one or more databases 920. The database(s) 920 may reside in a variety of locations. By way of example, a database 620 may reside on a storage medium local to (and/or resident in) one or more of the computers 902, 904, 906, 912, 914, 916, 918. Alternatively, it may be remote from any or all of the computers 902, 904, 906, 912, 914, 916, 918, and/or in communication (e.g., via the network 910) with one or more of these. In a particular set of embodiments, the database 920 may reside in a storage-area network (“SAN”) familiar to those skilled in the art. Similarly, any necessary files for performing the functions attributed to the computers 902, 904, 906, 912, 914, 916, 918 may be stored locally on the respective computer and/or remotely, as appropriate. In one set of embodiments, the database 920 may be a relational database, such as Oracle 10g, that is adapted to store, update, and retrieve data in response to SQL-formatted commands.

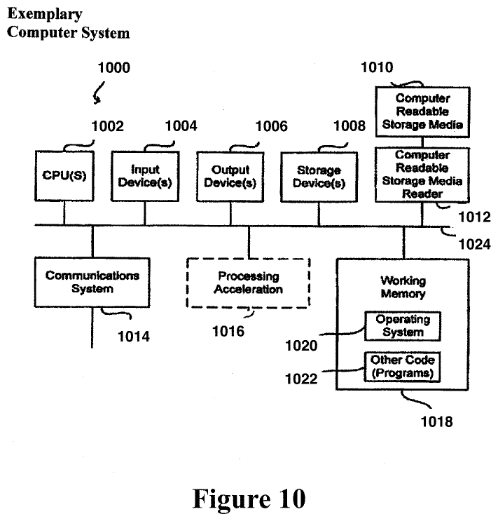

FIG. 10 illustrates an exemplary computer system 1000, in which embodiments of the present invention may be implemented. The system 1000 may be used to implement any of the computer systems described above. The computer system 1000 is shown comprising hardware elements that may be electrically coupled via a bus 1024. The hardware elements may include one or more central processing units (CPUs) 1002, one or more input devices 1004 (e.g., a mouse, a keyboard, etc.), and one or more output devices 1006 (e.g., a display device, a printer, etc.). The computer system 1000 may also include one or more storage devices 1008. By way of example, the storage device(s) 1008 can include devices such as disk drives, optical storage devices, solid-state storage device such as a random-access memory (“RAM”) and/or a read-only memory (“ROM”), which can be programmable, flash-updateable and/or the like.

The computer system 1000 may additionally include a computer-readable storage media reader 1012, a communications system 1014 (e.g., a modem, a network card (wireless or wired), an infra-red communication device, etc.), and working memory 1018, which may include RAM and ROM devices as described above. In some embodiments, the computer system 1000 may also include a processing acceleration unit 1016, which can include a digital signal processor DSP, a special-purpose processor, and/or the like.

The computer-readable storage media reader 1012 can further be connected to a computer-readable storage medium 1010, together (and, optionally, in combination with storage device(s) 1008) comprehensively representing remote, local, fixed, and/or removable storage devices plus storage media for temporarily and/or more permanently containing, storing, transmitting, and retrieving computer-readable information. The communications system 1014 may permit data to be exchanged with the network and/or any other computer described above with respect to the system 1000.

The computer system 1000 may also comprise software elements, shown as being currently located within a working memory 1018, including an operating system 1020 and/or other code 1022, such as an application program (which may be a client application, Web browser, mid-tier application, RDBMS, etc.). It should be appreciated that alternate embodiments of a computer system 1000 may have numerous variations from that described above. For example, customized hardware might also be used and/or elements might be implemented in hardware, software (including portable software, such as applets), or both. Further, connection to other computing devices such as network input/output devices may be employed.

Storage media and computer readable media for containing code, or portions of code, can include any appropriate media known or used in the art, including storage media and communication media, such as but not limited to volatile and non-volatile, removable and non-removable media implemented in any method or technology for storage and/or transmission of information such as computer readable instructions, data structures, program modules, or other data, including RAM, ROM, EEPROM, flash memory or other memory technology, CD-ROM, digital versatile disk (DVD) or other optical storage, magnetic cassettes, magnetic tape, magnetic disk storage or other magnetic storage devices, data signals, data transmissions, or any other medium which can be used to store or transmit the desired information and which can be accessed by the computer. Based on the disclosure and teachings provided herein, a person of ordinary skill in the art will appreciate other ways and/or methods to implement the various embodiments.

As discussed above, embodiments are suitable for use with the Internet, which refers to a specific global internetwork of networks. However, it should be understood that other networks can be used instead of the Internet, such as an intranet, an extranet, a virtual private network (VPN), a non-TCP/IP based network, any LAN or WAN or the like.

FIG. 10 further illustrates an environment where an on-demand distributed database service might be used. As illustrated in FIG. 10 user systems might interact via a network with an on-demand database. Some on-demand databases may store information from one or more records stored into tables of one or more distributed database images to form a database management system (DBMS). Accordingly, on-demand database and system will be used interchangeably herein. A database image may include one or more database objects. A relational database management system (RDMS) or the equivalent may execute storage and retrieval of information against the database object(s). Some on-demand database services may include an application platform that enables creation, managing and executing one or more applications developed by the provider of the on-demand database service, wherein users access the on-demand database service via user systems, or third party application developers access the on-demand database service via user systems.

The security of a particular user system might be entirely determined by permissions (permission levels) for the current user. For example, where a user account identification transaction may involve a portable identification alpha-numeric data field physically or digitally linked to a personal primary identification device to request services from a provider account and wherein the user is using a particular user system to interact with System, that user system has the permissions allotted to that user account. However, while an administrator is using that user system to interact with System, that user system has the permissions allotted to that administrator. In systems with a hierarchical role model, users at one permission level may have access to applications, data, and database information accessible by a lower permission level user, but may not have access to certain applications, database information, and data accessible by a user at a higher permission level. Thus, different users will have different permissions with regard to accessing and modifying application and database information, depending on a user's security or permission level.

A network can be a LAN (local area network), WAN (wide area network), wireless network, point-to-point network, star network, token ring network, hub network, or other appropriate configuration. As the most common type of network in current use is a TCP/IP (Transfer Control Protocol and Internet Protocol) network such as the global internetwork of networks often referred to as the “Internet” with a capital “I,” that will be used in many of the examples herein. However, it should be understood that the networks that the present invention might use are not so limited, although TCP/IP is a frequently implemented protocol.

User systems might communicate with a system using TCP/IP and, at a higher network level, use other common Internet protocols to communicate, such as HTTP, FTP, AFS, WAP, etc. In an example where HTTP is used, a user system might include an HTTP client commonly referred to as a “browser” for sending and receiving HTTP messages to and from an HTTP server at System. Such HTTP server might be implemented as the sole network interface between a system and network, but other techniques might be used as well or instead. In some implementations, the interface between a system and network includes load sharing functionality, such as round-robin HTTP request distributors to balance loads and distribute incoming HTTP requests evenly over a plurality of servers. At least as for the users that are accessing that server, each of the plurality of servers has access to at least one third party entity system data schema; however, other alternative configurations are contemplated.

According to one arrangement, each user system and all of its components are operator configurable using applications, such as a browser, including computer code run using a central processing unit such as an Intel Pentium® processor or the like. Similarly, a computer system (and additional instances of an enterprise database, where more than one is present) and all of their components might be operator configurable using application(s) including computer code run using a central processing unit such as an Intel Pentium® processor or the like, or multiple processor units. A computer program product aspect includes a machine-readable storage medium (media) having instructions stored thereon/in which can be used to program a computer to perform any of the processes of the embodiments described herein. Computer code for operating and configuring systems to intercommunicate and to process web pages, applications and other data and media content as described herein is preferably downloaded and stored on a hard disk, but the entire program code, or portions thereof, may also be locally stored in any other volatile or non-volatile memory medium or device as is well known, such as a ROM or RAM, or provided on any media capable of storing program code, such as any type of rotating media including floppy disks, optical discs, digital versatile disk (DVD), compact disk (CD), microdrive, and magneto-optical disks, and magnetic or optical cards, nano systems (including molecular memory ICs), or any type of media or device suitable for storing instructions and/or data. Additionally, the entire program code, or portions thereof, may be transmitted and downloaded from a software source over a transmission medium, e.g., over the Internet, or from another server, as is well known, or transmitted over any other conventional network connection as is well known (e.g., extranet, VPN, LAN, etc.) using any communication medium and protocols (e.g., TCP/IP, HTTP, HTTPS, Ethernet, etc.) as are well known. It will also be appreciated that computer code for implementing aspects of the present invention can be implemented in any programming language that can be executed on a client system and/or server or server system such as, for example, in C, C++, HTML, any other markup language, Java™, JavaScript, ActiveX, any other scripting language such as VBScript, and many other programming languages as are well known. (Java™ is a trademark of Sun Microsystems, Inc.).

While various embodiments of the disclosed technology have been described above, it should be understood that they have been presented by way of example only, and not of limitation. Likewise, the various diagrams may depict an example architectural or other configuration for the disclosed technology, which is done to aid in understanding the features and functionality that may be included in the disclosed technology. The disclosed technology is not restricted to the illustrated example architectures or configurations, but the desired features may be implemented using a variety of alternative architectures and configurations. Indeed, it will be apparent to one of skill in the art how alternative functional, logical or physical partitioning and configurations may be implemented to implement the desired features of the technology disclosed herein. Also, a multitude of different constituent module names other than those depicted herein may be applied to the various partitions. Additionally, with regard to flow diagrams, operational descriptions and method claims, the order in which the steps are presented herein shall not mandate that various embodiments be implemented to perform the recited functionality in the same order unless the context dictates otherwise.

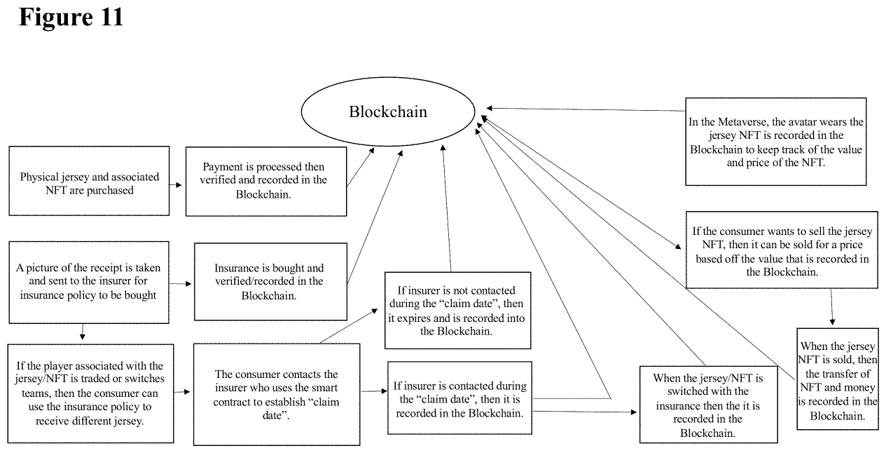

FIG. 11 is a diagram illustrating the Smart Contracts that are recorded in the Blockchain. The diagram begins with when the physical jersey is bought in a brick-and-mortar store, then an associated NFT is also purchased. From there, when the payment is processed through the store's POS, then it is verified and recorded into the Blockchain. When the physical jersey and associated NFT are bought, a picture of the receipt is taken and sent to the insurer for an insurance policy to be bought. Once this insurance policy is bought, it is then verified and recorded in the Blockchain and then a smart contract is sent out as notice. From there, if the player associated with the physical jersey and NFT is traded or switches teams during the allotted time period, then the consumer can use the insurance policy to trade in for a new jersey of the same player on the new team or a different player on the original team. When this player is traded or switches teams, the consumer contacts the insurer who uses the smart contract to establish the “claim date”. If the consumer does not contact the insurer within the “claim date”, then it expires and is recorded in the Blockchain. If the consumer does contact the insurer within the “claim date”, then the jersey is switched, and this is recorded into the Blockchain.

Within the Metaverse, the avatar wears the NFT jersey to virtual events and games. This is recorded in the Blockchain to keep track of the price and value of the NFT. If the consumer wants to sell the NFT, it can be sold for a price based off of the value that is recorded within the Blockchain. When the jersey NFT is sold, then the transfer of NFT and money is recorded within the Blockchain.

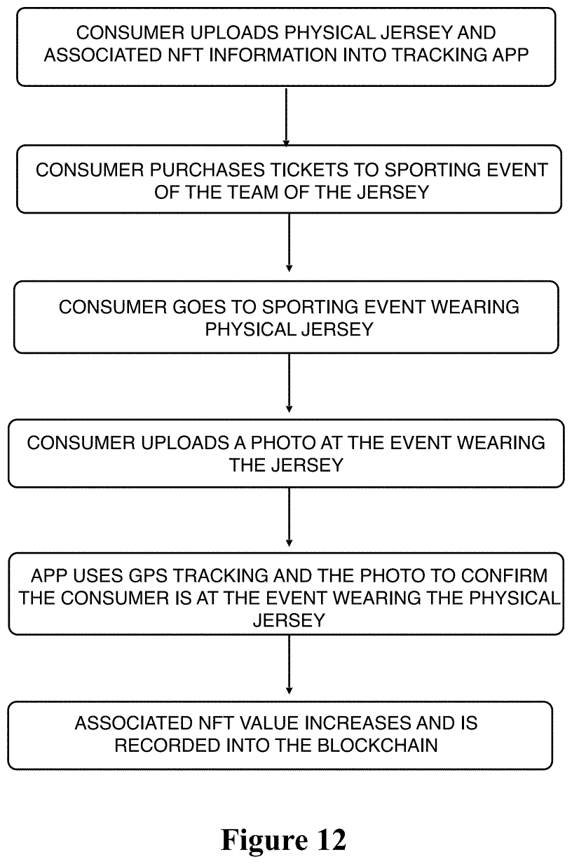

FIG. 12 is a flow diagram of the tracking app. On the tracking app, when the consumer wears the physical jersey, the associated NFT value can increased. The consumer will upload the information of the physical jersey and the associated NFT into the app. When the consumer wears the jersey to a sporting event of the team that the jersey is associated with, the consumer will upload a picture into the app. With the use of GPS tracking services and the photo, the app will confirm that the jersey is being worn at the event. Once this is confirmed, the value of the NFT will increase and will be recorded into the blockchain.

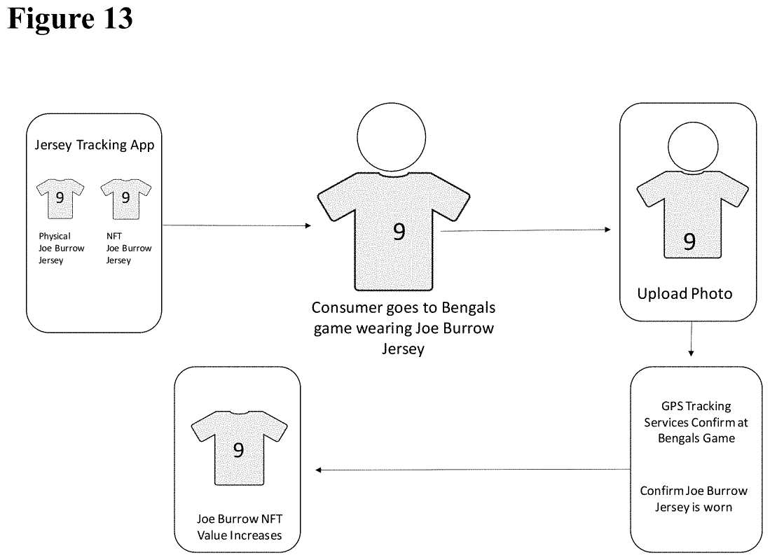

FIG. 13 is a diagram illustrating the tracking app. The consumer will upload the information of the physical jersey and the associated NFT. The consumer will attend a sporting event for the team whose jersey they own. Once at the event, the consumer will take a photo of the jersey and upload it into the tracking app. The app will use the GPS tracking services and photo to confirm the consumer is at the event wearing the jersey. The app will then allow for the NFT to increase in value.

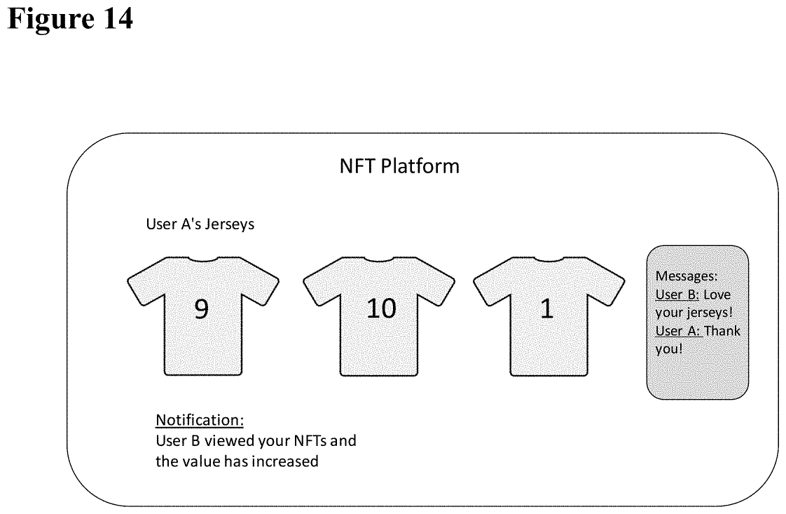

FIG. 14 is a diagram of the NFT platform. On this platform, users can upload all NFT jerseys, which can be seen by other users. When users view others NFTs, the NFT's value will increase. The platform is like a social media platform, using notifications and messaging to connect users on the platform.

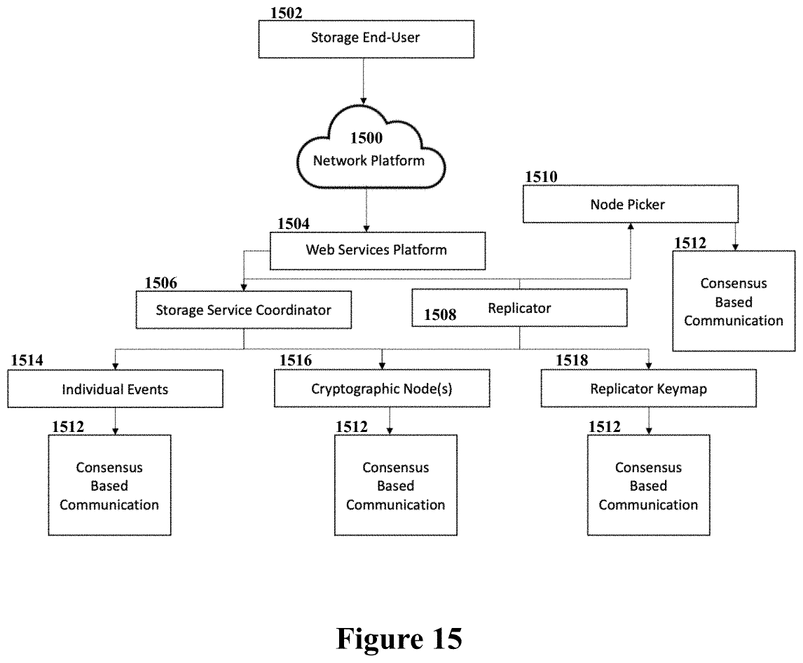

FIG. 15 is a diagram showing the communication between the storage end users 1502, the network platform 1500 and the various elements that help effectuate operations. The storage end user 1502 communicates and relays various pertinent bits of data to the network platform 1500. The network platform 1500 operates on the web service platform 1504, which features a storage service coordinator 1506 and replicator 1508. Each of these services utilize a node picker 1510 which helps establish consensus-based communication 1512. The storage service coordinator 1506 maintains and records individual events 1514 and cryptographic nodes 1516, or keys that are used for operations. The replicator has its own keymap 1518 which generates consensus-based communication 1512, alongside the cryptographic nodes 1516 and individual events 1514.

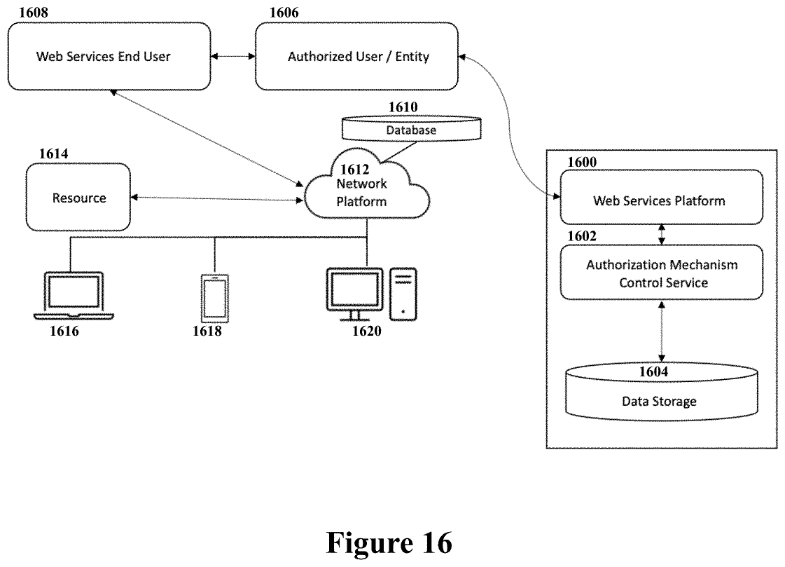

FIG. 16 is a diagram showing the web services of the platform and system. The platform and system are all components of an exemplary operating environment in which embodiments of the present invention may be implemented. The system can include one or more user computers, computing devices, or processing devices which can be used to operate a client, such as a dedicated application, web browser, etc. The user computers can be general purpose personal computers (including, merely by way of example, personal computers and/or laptop computers 1616 running a standard operating system), cell phones or PDAs 1618 (running mobile software and being Internet, e-mail, SMS, Blackberry, or other communication protocol enabled), and/or workstation computers 1620 running any of a variety of commercially-available UNIX or UNIX-like operating systems (including without limitation, the variety of GNU/Linux operating systems). These user computers may also have any of a variety of applications, including one or more development systems, database client and/or server applications, and Web browser applications. Alternatively, the user computers may be any other electronic device, such as a thin-client computer, Internet-enabled gaming system, and/or personal messaging device, capable of communicating via a network (e.g., the network described below) and/or displaying and navigating Web pages or other types of electronic documents. Although the exemplary system is shown with four user computers, any number of user computers may be supported.

In most embodiments, the system includes some type of network. The network can be any type of network familiar to those skilled in the art that can support data communications using any of a variety of commercially-available protocols, including without limitation TCP/IP, SNA, IPX, AppleTalk, and the like. Merely by way of example, the network can be a local area network (“LAN”), such as an Ethernet network, a Token-Ring network and/or the like; a wide-area network; a virtual network, including without limitation a virtual private network (“VPN”); the Internet; an intranet; an extranet; a public switched telephone network (“PSTN”); an infra-red network; a wireless network (e.g., a network operating under any of the IEEE 802.11 suite of protocols, GRPS, GSM, UMTS, EDGE, 2G, 2.5G, 3G, 4G, WiMAX, WiFi, CDMA 2000, WCDMA, the Bluetooth protocol known in the art, and/or any other wireless protocol); and/or any combination of these and/or other networks.

The system may also include one or more server computers which can be general purpose computers, specialized server computers (including, merely by way of example, PC servers, UNIX servers, mid-range servers, mainframe computers rack-mounted servers, etc.), server farms, server clusters, or any other appropriate arrangement and/or combination. One or more of the servers may be dedicated to running applications, such as a business application, a Web server, application server, etc. Such servers may be used to process requests from user computers. The applications can also include any number of applications for controlling access to resources 1614 of the servers.

The web server can be running an operating system including any of those discussed above, as well as any commercially-available server operating systems. The Web server can also run any of a variety of server applications and/or mid-tier applications, including HTTP servers, FTP servers, CGI servers, database servers, Java servers, business applications, and the like. The server(s) also may be one or more computers which can be capable of executing programs or scripts in response to the user computers. As one example, a server may execute one or more Web applications. The Web application may be implemented as one or more scripts or programs written in any programming language, such as Java®, C, C #, or C++, and/or any scripting language, such as Perl, Python, or TCL, as well as combinations of any programming/scripting languages. The server(s) may also include database servers, including without limitation those commercially available from Oracle®, Microsoft®, Sybase®, IBM® and the like, which can process requests from database clients running on a user computer.

End users 1608, or users that are viewing and using the network platform 1612, all contribute data to the cloud. A web service platform 1600 helps secure that data and maintain the service's functionalities. Only authorized users and entities 1606 can authorize or unauthorize content and monitor data stored within the web service. The platform's web services 1600 help maintain the operations of elements through the authorization mechanism control service 1602 managed by the data storage system 1604.

The system may also include one or more databases 1610. The database(s) 1610 may reside in a variety of locations. By way of example, a database 1610 may reside on a storage medium local to (and/or resident in) one or more of the computers 1620. Alternatively, it may be remote from any or all of the computers, and/or in communication (e.g., via the network) with one or more of these. In a particular set of embodiments, the database may reside in a storage-area network (“SAN”) familiar to those skilled in the art. Similarly, any necessary files for performing the functions attributed to the computers may be stored locally on the respective computer and/or remotely, as appropriate. In one set of embodiments, the database may be a relational database, such as Oracle 10g, that is adapted to store, update, and retrieve data in response to SQL-formatted commands.

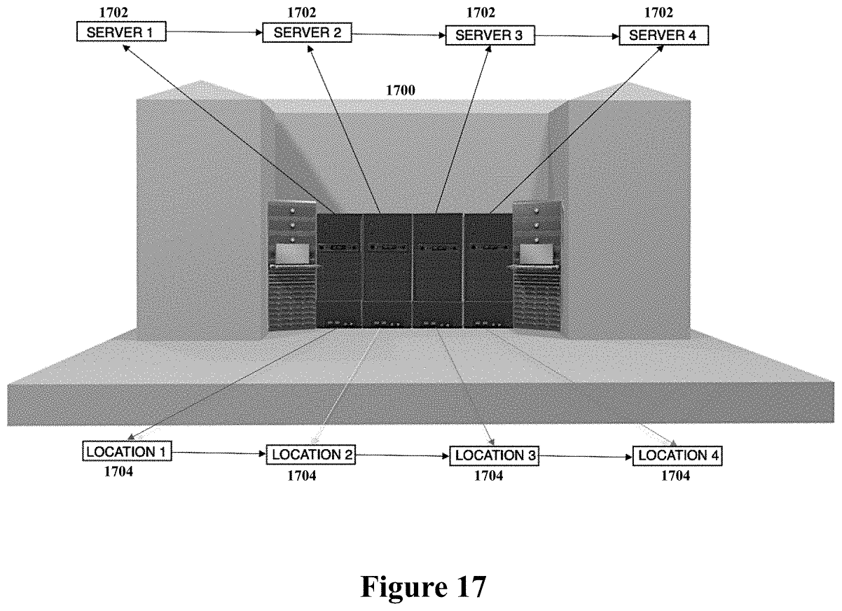

FIG. 17 is an illustration of server-to-server connections 1702, within a server room 1700 and to other sever room locations 1704. The web server undergoes an initialization process and features a database of wireless network data. Dependent on the service requested, the data may undergo processing. The servers 1702 actively attempt to retrieve the appropriate data to provide user input. Data may then be formatted, and with the appropriate authorizations, saved or restructured.

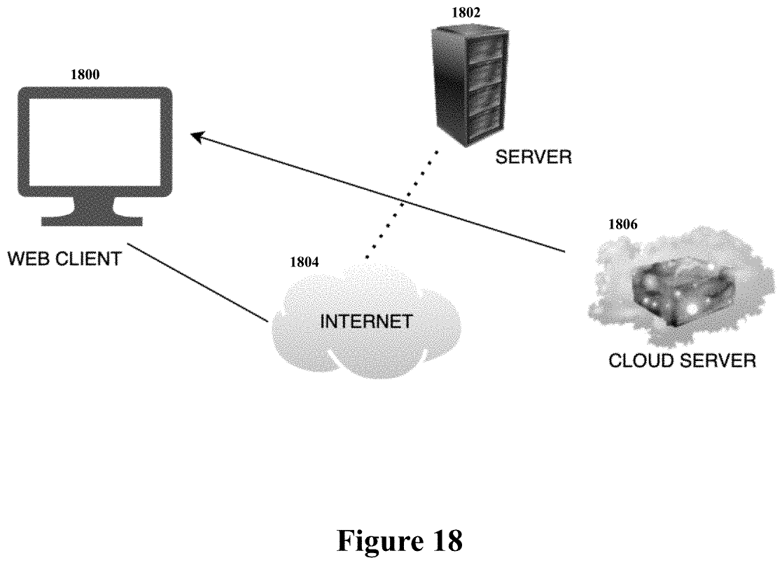

FIG. 18 is a diagram outlining the role of web services in the present invention. In accordance with the preferred embodiment, a web client 1800 interacts with the server ecosystem 1802 by way of a service connection, such as the internet 1804, which then distributes data and pertinent information such as the web service platform to the cloud server 1806 and preliminary servers. This allows for data to be streamlined between the client 1800 and the server 1802 as well as cloud servers 1806 and other database systems. Communication between web services may be completed via Simple Object Access Protocol (SOAP) which allows multiple web service applications to communicate rapidly and efficiently and to provide data to the web client.

The infrastructure of the present invention also allows for the use of web services that enable interaction with and storage of data across devices. Specifically, these web services can allow for the use of cloud software tools and cloud-based data storage. Cloud software tools can be used to allow for increased user authentication and authorization checkpoints for data accessed between parties. The web service software aids in the transmission of data between entities while still maintaining secure access restrictions preventing any unauthorized access to the cloud data.

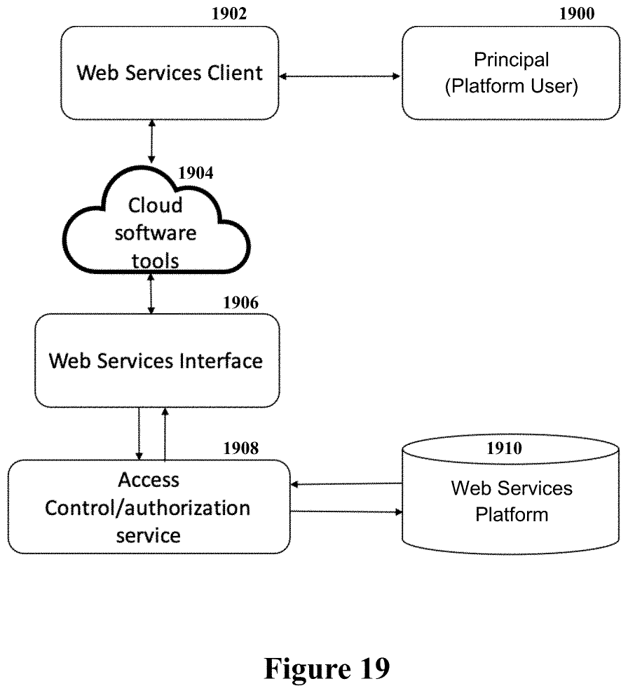

FIG. 19 is a diagram of the flow of access between the platform of the present invention and the web services client via cloud software tools. The principal or platform user 1900 accesses the web services client 1902, which then transmits data via cloud software tools 1904 to the web services interface 1906. Access control and authorization 1908 acts as a layer in order to access the web services platform 1910 by way of the web services interface 1906.

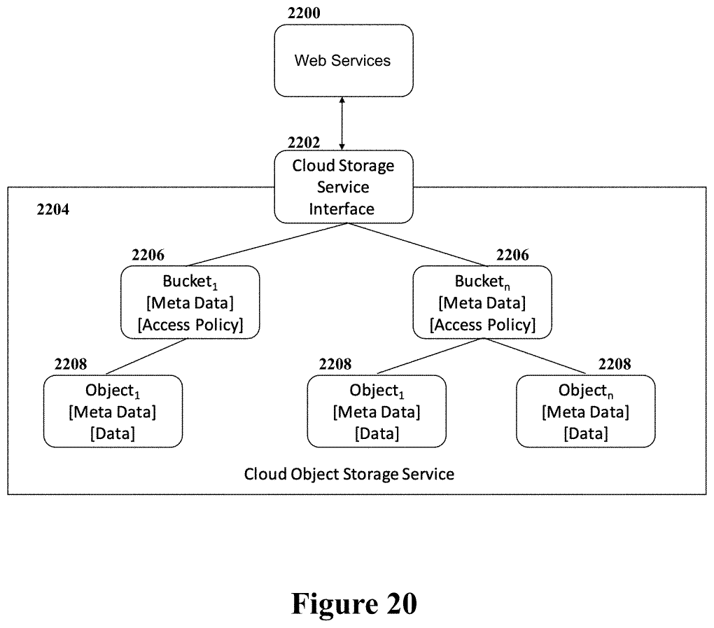

FIG. 20 is a diagram of an example of the cloud storage organization in which the web services 2000 accesses and retrieves user data as objects 2008 in buckets 2006 within a cloud storage space 2004. The cloud storage 2004 service is a means of storing and protecting any amount of data for a range of use cases. A bucket 2006 is a container for objects stored in the cloud storage service 2004, and objects 2008 consist of object data and metadata. The metadata is a set of name-value pairs that describe the object. These pairs include some default metadata, such as the date last modified, and standard HTTP metadata, such as Content-Type. You can also specify custom metadata at the time that the object is stored. Web services 2000 provide access to and from the cloud object storage service 2004 via the cloud storage service interface 2002.

While various embodiments of the disclosed technology have been described above, it should be understood that they have been presented by way of example only, and not of limitation. Likewise, the various diagrams may depict an example architectural or other configuration for the disclosed technology, which is done to aid in understanding the features and functionality that may be included in the disclosed technology. The disclosed technology is not restricted to the illustrated example architectures or configurations, but the desired features may be implemented using a variety of alternative architectures and configurations. Indeed, it will be apparent to one of skill in the art how alternative functional, logical or physical partitioning and configurations may be implemented to implement the desired features of the technology disclosed herein. Also, a multitude of different constituent module names other than those depicted herein may be applied to the various partitions. Additionally, with regard to flow diagrams, operational descriptions and method claims, the order in which the steps are presented herein shall not mandate that various embodiments be implemented to perform the recited functionality in the same order unless the context dictates otherwise.

Although the disclosed technology is described above in terms of various exemplary embodiments and implementations, it should be understood that the various features, aspects and functionality described in one or more of the individual embodiments are not limited in their applicability to the particular embodiment with which they are described, but instead may be applied, alone or in various combinations, to one or more of the other embodiments of the disclosed technology, whether or not such embodiments are described and whether or not such features are presented as being a part of a described embodiment. Thus, the breadth and scope of the technology disclosed herein should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

1. A method comprising:
identifying, by way of a plurality of computer processors, a purchased sports player garment associated with a non-fungible token, featuring a unique identifier;
verifying said purchased sports player garment by generating proof of purchase data at a point-of-sale terminal;
insuring said desirable sports player garment associated with said non-fungible token;
storing and securing purchase data of said sports player garment on a blockchain ledger;
connecting, by way of said plurality of computer processors, purchase data associated with said sports player article and non-fungible token, which corresponds with said unique identifier on said blockchain ledger;
recording, by way of a plurality of nodes in a distributed and decentralized network, purchase data of said non-fungible token on said blockchain ledger;
exemplifying, by way of one or more general purpose processors, a platform comprising of said purchase data profile, proof of ownership data, and said non-fungible token on said blockchain ledger; and
trading and selling said non-fungible tokens associated with said sports player garment or articles on said blockchain ledger offering owners of said sports player garment owners an opportunity to trade in said sports player garment for a new sports player garment in the event a player associated with said sports player garment changes teams.

2. The method according to claim 1, wherein said platform supports image uploads of said owner in said sports player garment and generates and stores the image metadata.

3. The method according to claim 1, wherein said non-fungible token is given an updated value by way of smart contract terms met when said non-fungible token associated with said sports player garment is worn at a sporting event.

4. The method according to claim 2, wherein said image data includes GPS tracking data derived from an image upload from a user with said sports player garment corresponding with said non-fungible token on.

5. The method according to claim 1, further comprising of a node-picker for said plurality of nodes to establish consensus-based communication to validate said nodes on said distributed network for staking of said sports player garment's non-fungible token.

6. The method according to claim 1, wherein said sports player garment utilizes an RFID chip for GPS tracking.

7. The method according to claim 1, wherein said distributed network is supported by a web-services platform wherein authorized users may monitor said non-fungible token data that is stored and archived within a data storage system and storage area network to ensure it corresponds with said GPS and tracking data for non-fungible token valuation.

8. A method comprising:
identifying, by way of a plurality of computer processors, a purchased sports player garment associated with a non-fungible token, featuring a unique identifier;
verifying said purchased sports player garment by generating proof of purchase data at a point-of-sale terminal;
insuring said desirable sports player garment associated with said non-fungible token;
storing and securing purchase data of said sports player garment on a blockchain ledger and memory coupled to said plurality of computer processors;
connecting, by way of said plurality of computer processors, purchase data associated with said sports player article and non-fungible token, which corresponds with said unique identifier on said blockchain ledger;
recording, by way of a plurality of nodes in a distributed and decentralized network, purchase data of said non-fungible token on said blockchain ledger;
exemplifying, by way of one or more general purpose processors, a platform comprising of said purchase data profile, proof of ownership data, and said non-fungible token on said blockchain ledger;
valuating said non-fungible token associated with said sports player garment using GPS and tracking data of the presence of said sports player garment in an event; and
trading and selling said non-fungible tokens associated with said desirable articles on said blockchain ledger offering owners of said sports player garment owners an opportunity to trade in said sports player garment for a new sports player garment in the event a player associated with said sports player garment changes teams.

9. The method according to claim 8, wherein said platform supports image uploads of said owner in said sports player garment and generates and stores the image metadata.

10. The method according to claim 8, wherein said non-fungible token is given an updated value by way of smart contract terms met when said non-fungible token associated with said sports player garment is worn at a sporting event.

11. The method according to claim 9, wherein said image metadata includes GPS tracking data derived from an image upload from a user with said sports player garment corresponding with said non-fungible token on.

12. The method according to claim 8, further comprising of a node-picker for said plurality of nodes to establish consensus-based communication to validate said nodes on said distributed network for staking of said sports player garment's non-fungible token.

13. The method according to claim 12, wherein said distributed network is supported by a web-services platform wherein authorized users may monitor said non-fungible token data that is stored and archived within a data storage system and storage area network to ensure it corresponds with said GPS and tracking data for non-fungible token valuation.

14. The method according to claim 8, wherein said non-fungible token's valuation also factors in the number of times said non-fungible token has been viewed on said platform.

15. A non-fungible token valuation system for dictating a non-fungible token corresponding with a purchased physical player sports garment's value on an exchange platform, the system comprising:
a purchased physical player sports garment, generating proof of purchase data at a point-of-sale terminal;
a non-fungible token, deriving from said proof of purchase data set from said point-of-sale terminal, recorded on a blockchain ledger in a distributed network;
a network platform, presenting a web-service interface to facilitate interactions among users and web-service clients, capable of transmitting data by way of cloud software tools;
a computing device, operating a client, utilizing local storage to capture image meta-data;
a GPS tracking system, generating meta-data captured from said image;
a processing device, utilizing processing cores to understand and execute computer-readable code;
a machine-readable storage medium, configured to store and maintain data regarding a player sports garment and said metadata regarding said physical sports player garment from a file upload;
a database server, wherein said database server stores sporting event data from a plurality of uploaders on said platform; and
a 3D online virtual environment, supporting said file uploads; and
a non-fungible token valuation system, wherein said plurality of uploaders influence the value of a non-fungible token based off the prevalence of a particular physical sports player garment uploaded to said database server.

16. The database server according to claim 17, wherein said database server maintains user data, such as the number of times a physical player sports garment with a corresponding non-fungible token has been worn at a sporting event.

17. The non-fungible token valuation system according to claim 18, further comprising of a usage provenance that increases said value of said non-fungible token associated with said physical player sports garment.

18. The non-fungible token according to claim 17, wherein said non-fungible token is associated with a purchased, physical player sports garment and records point-of-sale terminal data on said blockchain.

19. The system according to claim 17, wherein said non-fungible token's valuation also factors in the number of times said non-fungible token has been viewed on said platform.

20. The 3D virtual reality according to claim 17, wherein said 3D virtual reality includes the Metaverse, and users garb their virtual counterpart with said non-fungible token corresponding with said physical player sports garment.
